(19) United States
(12) Patent Application Publication
(10) Pub. No.: US 2009/0271766 A1
(43) Pub. Date: Oct. 29, 2009

(54) METHODS, SYSTEMS AND COMPUTER PROGRAM PRODUCTS FOR IMPROVING PROGRAM PERFORMANCE BY ANTI-REFACTORING

(75) Inventors: Jing Luo, Bei Jing (CN); John A. Pershing Jr., Cortlandt Manor, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/111,243

(22) Filed: Apr. 29, 2008

(51) Int. Cl. G06F 9/44

(52) U.S. Cl. 717/124

(57) ABSTRACT

A method for developing a computer program product includes: evaluating one or more refactoring actions to determine a performance attribute; associating the performance attribute with a refactoring action used in computer code; and undoing the refactoring action of the computer code based on the performance attribute.

### BACKGROUND

1. Field

This disclosure relates to methods, systems, and computer program products for compiling computer software code.

2. Description of Background

Refactoring is used in current software development processes to “clean up” computer program code by for example, changing function calls, variable names, and code structure, without changing the results of the computer code. Refactoring is commonly performed prior to compilation to improve readability or simplicity of code structure. However, in some cases performance of the program generated by the computer code may be degraded by the code refactoring action.

### SUMMARY

The shortcomings of the prior art are overcome and additional advantages are provided through the provision of a method for developing a computer program product. The method includes: evaluating one or more refactoring actions to determine a performance attribute: associating the performance attribute with a refactoring action used in computer code; and undoing the refactoring action of the computer code based on the performance attribute.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which solves the conflict between program performance and readability in the refactoring process. By analyzing the refactoring history, refactorings which degrade performance will be temporarily undone before compiling to regain the lost performance, but not affect the program's readability obtained by refactoring.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings.

FIG. 1 is a block diagram illustrating a computing system that includes an anti-refactoring system in accordance with an exemplary embodiment.

FIG. 2 is a block diagram illustrating the anti-refactoring system in accordance with an exemplary embodiment.

FIG. 3 illustrates a notation of refactoring history in accordance with an exemplary embodiment.

FIG. 4 is a flowchart illustrating an anti-refactoring method in accordance with an exemplary embodiment.

The detailed description explains the preferred embodiments of the invention, together with advantages and features, by way of example with reference to the drawings.

### DETAILED DESCRIPTION

Compensation for performance degradation due to refactoring is achieved through an anti-refactoring system of the present disclosure. Generally speaking, through the anti-refactoring system: common refactoring patterns are analyzed by a developer, and the refactoring actions that decrease performance are tagged as “Performance Issue Refactorings;” during source code development, a history of refactorings is maintained, and analyzed to determine whether any current refactoring will break any previous refactorings; and when the source code is compiled, any “Performance Issue Refactorings” in the history will be temporarily undone (anti-refactored) before compiling the code.

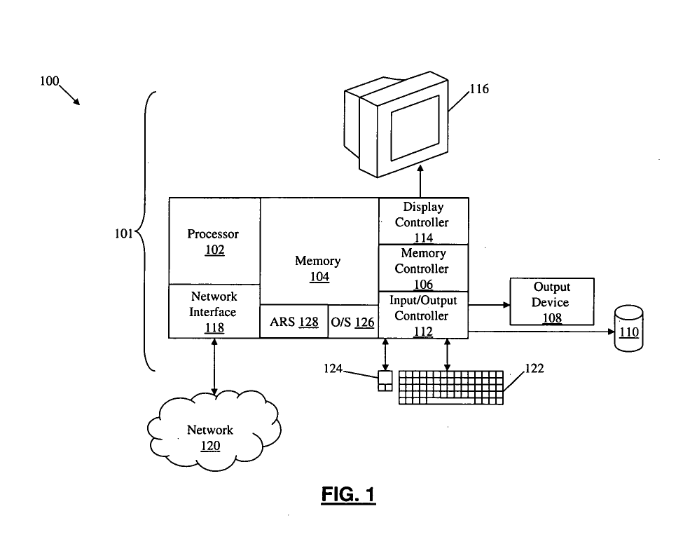

Turning now to FIG. 1, a block diagram illustrates an exemplary computing system 100 that includes an anti-refactoring system in accordance with the present disclosure. The computing system 100 is shown to include a computer 101. As can be appreciated, the computing system 100 can include any computing device, including but not limited to, a desktop computer, a laptop, a server, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, the system 100 can further include a network interface 118 for coupling to a network 120. The network 120 transmits and receives data between the computer 101 and external systems. In an exemplary embodiment, a conventional keyboard 122 and mouse 124 can be coupled to the input/output controller 112.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

In various embodiments, the memory 104 stores instructions that can be executed by the processor 102. The instructions stored in memory 104 may include one or more separate programs, each of which comprises an ordered listing of executable instructions for implementing logical functions. In the example of FIG. 1, the instructions stored in the memory 104 include a suitable operating system (OS) 126. The operating system 126 essentially controls the execution of other computer programs and provides scheduling, input-output control, file and data management, memory management, and communication control and related services. The instructions stored in memory 104 further include the anti-refactoring system 128 in accordance with the present disclosure. As generally discussed above and as will be discussed in more detail below, the anti-refactoring system 128 is a computer program development system that aids in improving the performance of the computer program by anti-refactoring computer code associated with the computer program prior to compilation.

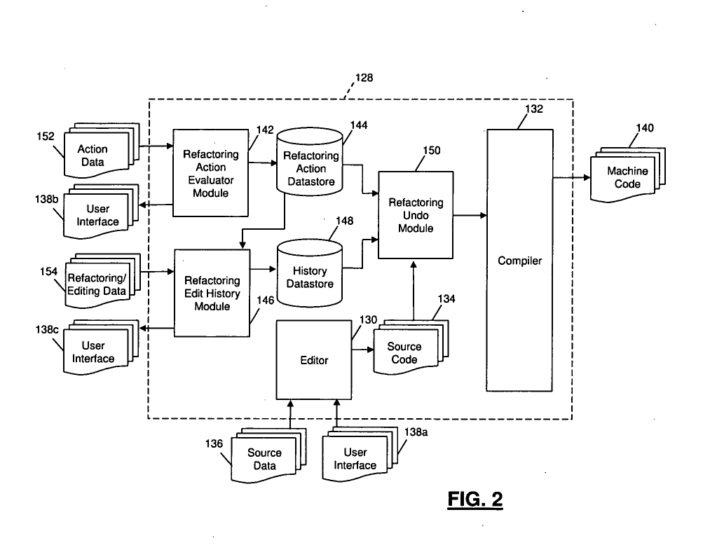

Referring now to FIG. 2, the anti-refactoring system 128 is shown in accordance with an exemplary embodiment. In various embodiments, the anti-refactoring system 128 may be included in an integrated development environment (IDE), as shown in FIG. 2 that includes an editor 130 and a compiler 132. In various other embodiments, the anti-refactoring system 128 may be implemented as a plug-in or a stand alone application.

The anti-refactoring system 128 can further include one or more modules and datastores. As can be appreciated, the modules shown in FIG. 2 can be combined and/or further partitioned to similarly perform anti-refactoring of source code as described herein. In one example, the anti-refactoring system 128 includes a refactoring action evaluator module 142, a refactoring action datastore 144, a refactoring and edit history module 146, a history datastore 148, and a refactoring undo module 150.

As shown in the example of FIG. 2, the editor 130 provides the functionality for a developer to write and edit source code 134, for example, by entering code data 136 into a user interface 138a. The compiler 132 translates the source code 134 into machine readable code 140.

The refactoring action evaluator module 142 allows a developer to develop, analyze, and/or experiment with refactoring actions by entering action data 152 via a user interface 138b. A refactoring action is an action that does not change the code logic function, and that can be captured or identified as an independent action. The refactoring action can include simple refactoring (e.g., a result of this kind of refactoring is not an obviously defined pattern) and/or pattern refactoring (e.g., a result of this kind is an obviously defined pattern).

The refactoring action evaluator module 142 then provides performance-related information as annotations to each of the refactoring actions. The performance-related information indicates a degree to which the refactoring may have an effect on the performance of the program. In one example, the annotated information can be a performance level or a time. Thus, each refactoring action in the meta-refactoring action datastore 144 includes data defining the refactoring action and performance information. Those refactoring actions that negatively affect performance are designated by the refactoring action evaluator module 142 as “performance issue refactorings”.

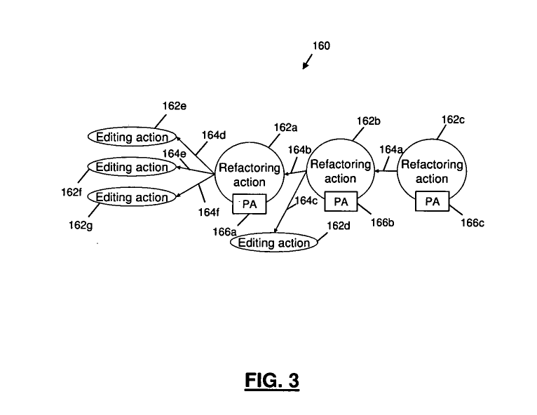

The refactoring and edit history module 146 records any refactoring and editing performed on the source code 134 for example, based on refactoring/editing data 154 entered by the developer via a user interface 138c. The refactoring and editing history module 146 represents the recorded refactoring and editing as a directed acyclic graph (DAG). For example, as shown in FIG. 3, a DAG 160 includes nodes 162a-162g and dependencies 164a-164f. The nodes 162a-162g denote the editing action or refactoring action taken by the developer. The dependencies 162a-162g are illustrated by the arcs between the nodes 162a-162g and denote the dependencies of each action, for example, that one action is performed based on the dependant actions. Each refactoring action node includes the associated performance related information or performance attribute (PA) 166a-166c as provided by the refactoring action datastore 144.

With reference back to FIG. 2, to record actions in the history datastore 148, the refactoring actions and performance data stored in the refactoring action datastore 144 are used to construct these DAGs. For refactoring actions whose performance effect is unknown, the developer can make decisions how this refactoring action will affect the program's performance and add the performance data while refactoring or editing.

The refactoring undo module 150 analyzes the DAGs 160 based on the annotated performance information. The refactoring undo module 150 modifies the source code to undo the refactoring when: the refactoring action does not have a dependency relationship on other refactoring actions in the DAGs; and the refactoring action is a “performance issue refactoring action.”

The compiler 132 then compiles this compiler-oriented source code based on the anti-refactored source code.

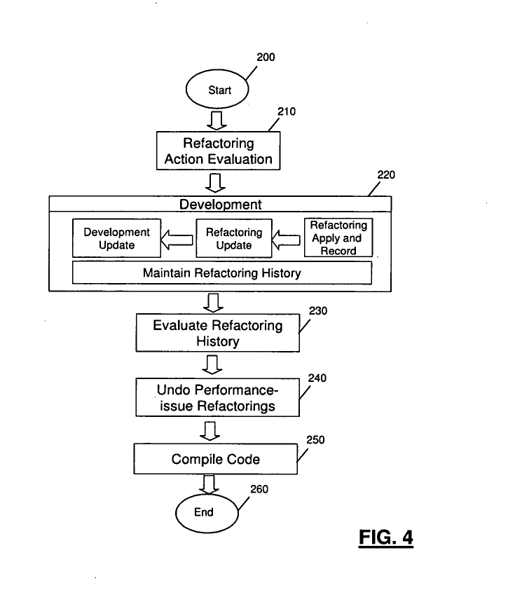

Referring now to FIG. 4, a method of anti-refactoring for performance improvement is shown in accordance with an exemplary embodiment. As can be appreciated in light of the disclosure, the order of operation within the method is not limited to the sequential execution as illustrated in FIG. 4, but may be performed in one or more varying orders as applicable, in accordance with the present teachings.

In one example, the method may begin at 200. The performance information is annotated for each refactoring action at 210. For example, the performance information can be performance level (e.g., several levels can be provided for the development expert such as high-positive, middle-positive, low-positive, no-influence, low-negative, middle-negative, high-negative) or performance time (e.g., how much time the refactoring may have influence on the program). The editing and refactoring of the source code is performed during development at 220. At this time, performance information can be added or modified by a developer. All of the refactoring and editing actions are maintained as DAGs and, along with the development activity, these DAGs are updated. Analysis is performed on the refactoring and editing history at 230. Those refactorings that do not have dependency relationships on other actions in the DAGs and that are performance-issue refactoring actions will be undone to generate the compiler-oriented source code at 240. The source code is then compiled at 250 and generates the executable program. Thereafter, the method may end at 260.

As can be appreciated, the capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for developing a computer program product, the method comprising:
evaluating one or more refactoring actions to determine a performance attribute;
associating the performance attribute with a refactoring action used in computer code; and
undoing the refactoring action of the computer code based on the performance attribute.

2. The method of claim 1 wherein the undoing refactoring is performed when the performance attribute indicates a negative performance effect of the computer code.

3. The method of claim 1 wherein the undoing refactoring is performed before the computer code is compiled.

4. The method of claim 1 further comprising determining the performance attribute to be at least one of a performance time and a performance level.

5. The method of claim 1 wherein the performance attribute is unknown, providing an interface for inputting the performance attribute.
